(19) United States
(12) Patent Application Publication
(10) Pub. No.: US 2003/0123176 A1
(43) Pub. Date: Jul. 3, 2003

(54) Method and apparatus for access control of a disk drive using extended command

(76) Inventors: Yutaka Arakawa, Ome-shi (JP); Koichi Chiba, Akiruno-shi (JP)

Correspondence Address: PILLSBURY WINTHROP, LLP, P.O. BOX 10500, MCLEAN, VA, 22102, US

(21) Appl. No.: 10/234,144

(22) Filed: Sep. 5, 2002

(30) Foreign Application Priority Data
Dec. 27, 2001 (JP) 2001-398476

(51) Int. Cl. G11B 21/02; G11B 19/04

(52) U.S. Cl. 360/60; 360/75

(57) ABSTRACT

There is disclosed a disk drive which uses a specific command (extended command) such as an AV command other than a usual read/write command. The preset disk drive processes a command issued from a host system as a usual read/write command, when the command is a specific command registered beforehand. Moreover, the present disk drive stops read/write access when the command is other than the usual read/write command and is an unregistered specific command.

### CROSS-REFERENCE TO RELATED APPLICATIONS

This application is based upon and claims the benefit of priority from the prior Japanese Patent Application No. 2001-398476, filed Dec. 27, 2001, the entire contents of which are incorporated herein by reference.

### BACKGROUND OF THE INVENTION

1. Field of the Invention

The present invention generally relates to the field of a disk drive, particularly to access control using extended read/write commands other than usual read/write commands.

2. Description of the Related Art

In recent years, a disk drive represented by a hard disk drive has been used as a storage apparatus in which not only computer data but also sound or image data (referred to generically as AV data) are stored. Different from computer data, the AV data is continuous stream data. Therefore, the disk drive is requested to maintain, for example, an arbitrary transfer rate in accordance with a data amount of images and sounds rather than correctness of data in access processing of the AV data. To maintain the transfer rate, the disk drive needs to complete the access processing within a limited time set by the host system.

Moreover, in an access to the AV data, a sequential read/write operation is required which comprises: continuously recording the data into sequentially continuing addresses on a disk recording medium (hereinafter referred to simply as a disk); or continuously reproducing the data from the disk.

From the above-described background, separately from a usual read/write command, specifications of a type of extended command (specific command) called an AV command (or a streaming command) have been studied. The disk drive processes the AV command having a code different from a command code of the usual read/write command from a personal computer or a host system such as a digital television apparatus.

It is necessary to interpose a microcontroller (CPU) of the drive in order to handle the AV command to which the command code different from the usual read/write command is allocated. Additionally, for the disk drive in recent years, the interposition of the CPU as a main controller of the drive has been minimized, and an automatic and high-speed read/write access system by a disk controller (HDC) has been used.

The processing of the extended commands such as the AV command causes a drop of access speed as compared with the usual read/write command processing, because the CPU is interposed. As described above, high-speed processing within a limited time has been required in the access to the AV data. Therefore, when simply extended commands such as the AV command for handing AV data are newly added, the automatic and high-speed read/write access system cannot be applied.

### BRIEF SUMMARY OF THE INVENTION

An object of the present invention is to provide a disk drive which realizes a high-speed read/write access using an extended command (or a specific command).

In accordance with one aspect of the present invention, there is provided a disk drive which executes a read/write access in response to a command issued from a host system and which executes a high-speed read/write access in response to extended or specific commands such as an AV command other than usual read/write commands.

The disk drive comprises: a read/write mechanism which executes a read/write operation of data with respect to a disk medium; and a controller to execute a control related to the read/write operation in accordance with a command issued from a host system, to judge whether or not the command is a registered specific read/write command, and to control the read/write mechanism similarly as a usual read/write command, when the judgment result indicates the specific read/write command.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram showing a constitution of a disk drive according to an embodiment of the present invention;

FIG. 2 is a block diagram showing a main part of a disk controller according to the present embodiment;

FIG. 3 is a block diagram showing a main part of a host interface block according to the present embodiment;

FIG. 4 is a flowchart showing a procedure of a command processing according to the present embodiment;

FIGS. 5A and 5B are explanatory views of a pre-read operation according to a first modification example;

FIG. 6 is a flowchart showing the procedure of the pre-read operation;

FIG. 7 is an explanatory view of a dynamic change of an extended command according to a second modification example; and

FIG. 8 is a flowchart showing a procedure concerning the dynamic change of the extended command.

### DETAILED DESCRIPTION OF THE INVENTION

An embodiment of the present invention will be described hereinafter with reference to the drawings.

(Constitution of Disk Drive)

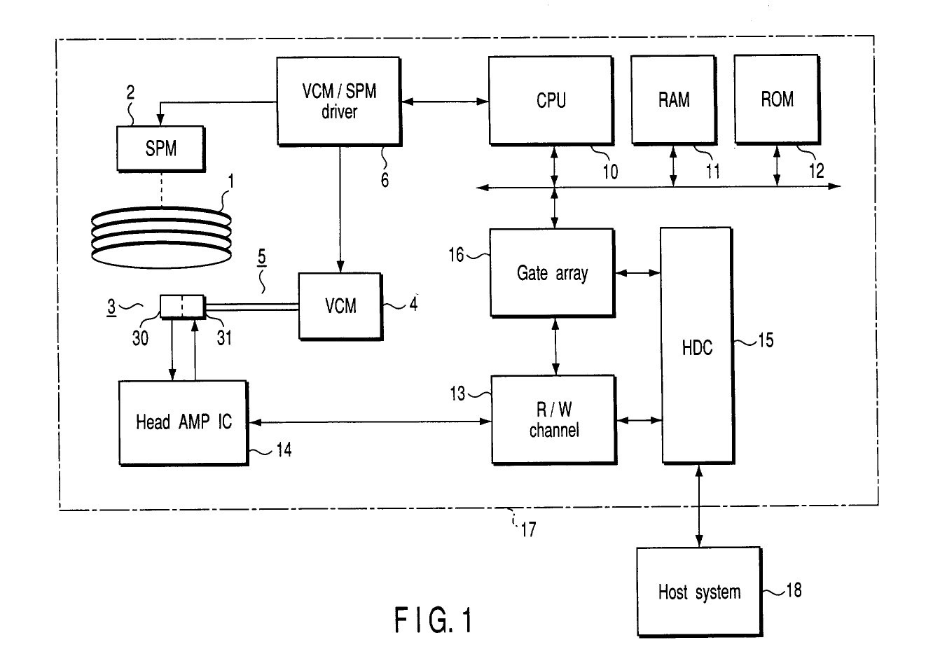

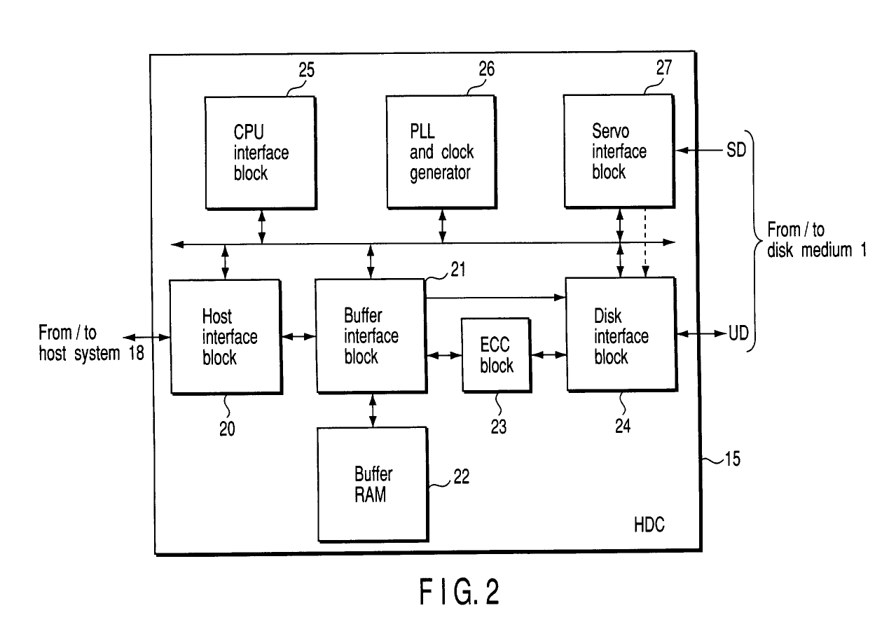

As shown in FIG. 1, a disk drive 17 of the present embodiment has a mechanism for accessing disks 1 as recording media and recording or reproducing data in response to a read/write command issued from a host system 18. The host system 18 is a digital apparatus such as a personal computer and digital television.

For the disks 1, one disk or a plurality of disks are attached to a spindle motor (SPM) 2 and rotated. The disk 1 includes a large number of data tracks having concentric circle shapes, and each data track is divided into a plurality of data sectors.

In an access operation, a head (magnetic head herein) 3 records data in data sector units of each data track, or reproduces the data from each data sector. The head 3 includes a read head 30 for performing data reproduction (read operation), and a write head 31 for performing data recording (write operation).

The head 3 is mounted on an actuator 5 including a voice coil motor (VCM) 4. The actuator 5 executes a seek operation of moving the head 3 in a radial direction on the disk 1 by the driving force of the VCM 4.

A motor driver IC 6 constituted by integrating SPM and VCM drivers supplies driving currents to the SPM 2 and VCM 4. The motor driver IC 6 is controlled by a CPU 10. The CPU 10 is also called a micro-controller, and is a main controller of the drive, which executes a control operation by a program stored in a ROM 12. A RAM 11 is used as a working memory in the control operation of the CPU 10.

Furthermore, the disk drive 17 includes: a read/write (R/W) channel 13; a head amplifier (preamplifier) IC 14; a disk controller (HDC) 15 including a buffer memory (buffer RAM); and a gate array 16.

The R/W channel 13 is a read/write signal processing circuit. The R/W channel 13 reproduces (decodes) original recording data from a read signal read by the read head 30 via the head amplifier IC 14, and sends the reproduced data (digital read data) to the HDC 15. Moreover, the R/W channel 13 receives write data from the HDC 15, encodes the data into predetermined recording data, and sends the data to the head amplifier IC 14.

The head amplifier IC 14 includes a read amplifier for amplifying the read signal from the read head 30, and a write amplifier for converting the encoded data from the R/W channel 13 into a write current. The gate array 16 includes a servo controller for reproducing servo data, an interface controller for exchanging various data or signals, and the like.

(Constitution of Disk Controller) The HDC 15 constitutes an interface with the drive 17 and host system 18, and receives the read/write command from the host system 18, or controls transfer of read/write data. The HDC 15 has a data transfer function by an automatic and high-speed data transfer mode in which involvement of the CPU 10 is minimal, and by a processor input/output (PIO) transfer mode in which the CPU 10 is involved.

The HDC 15 of the present embodiment includes: a host interface block (host IF) 20; a buffer interface block (buffer IF) 21; a buffer memory (buffer RAM) 22; an ECC block 23; and a disk interface block (disk IF) 24. Furthermore, the HDC 15 includes: a CPU interface block (CPU interface) 25; a PLL and clock generator 26; and a servo interface block (servo IF) 27.

The disk IF 24 and servo IF 27 are interfaces connected on a disk 1 side. The disk IF 24 is connected to the R/W channel 13, and controls the transfer of read/write data (user data) UD with respect to the disk 1. The servo IF 27 is connected to the servo controller included in the gate array 16, and inputs servo data SD reproduced from the disk 1.

The CPU interface 25 exchanges the commands and various types of control information with the CPU 10. The PLL and clock generator 26 generates a clock pulse necessary for the operation of the HDC 15, or executes a PLL operation for extracting a clock signal from the read data.

The buffer IF 21 is connected to the host IF 20 and disk IF 24, and executes read/write access control of the buffer RAM 22, or read/write cache control. The buffer RAM 22 is a buffer memory in which the read and write data are accumulated, and also functions as a pre-read buffer related to a read cache. The ECC block 23 is a block for executing error correction (ECC) processing of the read data.

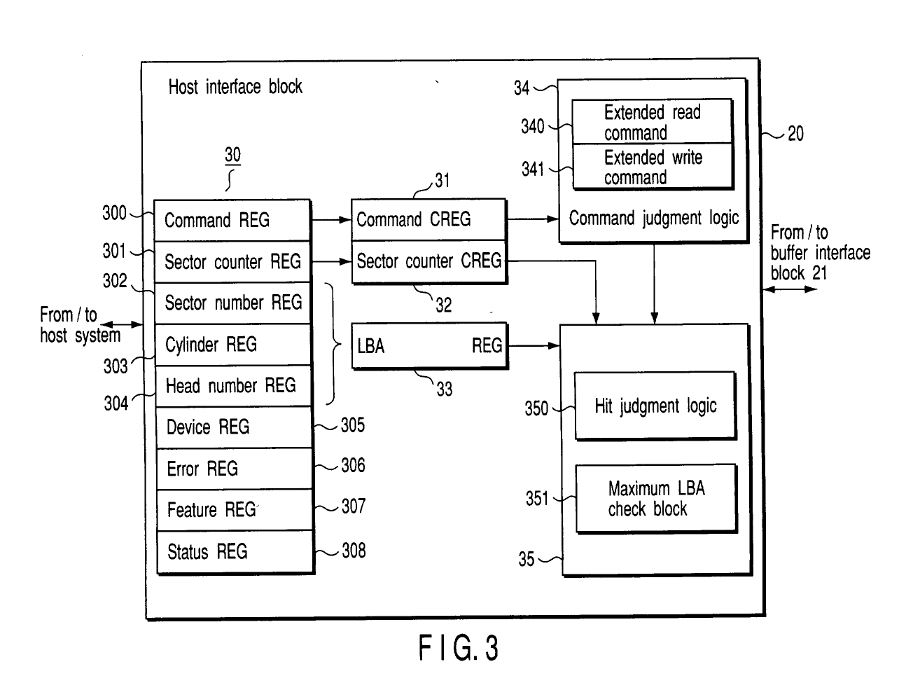

As shown in FIG. 3, the host IF 20 of the present embodiment includes: a register group 30, for example, according to the ATA interface standard; a command judgment logic block (command judgment logic) 34; and a control block 35.

The register group 30 can be accessed by the host system 18 and the CPU 10 in the drive. A command register 300 holds various command codes such as a read/write command issued from the host system 18 and an extended read/write command (specific read/write command) related to the present embodiment. A command code set in the command register 300 is copied by a command copy register 31. A sector counter register 301 holds the number of transfer sectors. The transfer sector number set in this register 301 is also copied by a copy register 32.

Furthermore, the register group 30 includes: a sector number register 302 for setting a CHS address; a cylinder register 303; and a head number register 304. Moreover, the register group includes: a device (drive) number register 305; an error register 306; a feature register 307; and a status register 308.

Here, in response to the read/write command from the host system 18, the host IF 20 converts a physical address as a CHS address (cylinder, head, sector numbers) to a logic address (LBA address), and sets the address into an LBA address register 33. The HDC 15 uses the LBA address to execute the read/write access to the data with respect to the disk 1. Additionally, the control block 35 of the host IF 20 includes a check block 351 for judging whether or not the LBA address set in the LBA address register 33 is within a maximum LBA address of an allowable range.

The command judgment logic 34 is a block for judging, for example, the extended read/write command corresponding to the AV command for accessing the AV data besides the usual read/write command from the host system 18. The command judgment logic 34 includes registers 340, 341 in which the extended read and write command codes are set/registered beforehand. The command judgment logic 34 compares the command code set in the command copy register 31 with the command codes registered in the registers 340, 341, and judges whether or not the codes agree with each other. When the extended read/write command issued from the host system 18 is a pre-registered valid command, the command judgment logic 34 judges the read/write command to be usual and starts up the control block 35.

As described above, the control block 35 communicates with the buffer IF 21 and with the disk IF 24 via the buffer IF 21, and executes control processing for executing a series of read/write accesses with respect to the read/write command. The control block 35 includes hit judgment logic 350 related to read and write caches, and judges whether or not the address designated by the read/write command is registered in a hit judgment table.

(Read/Write Access)

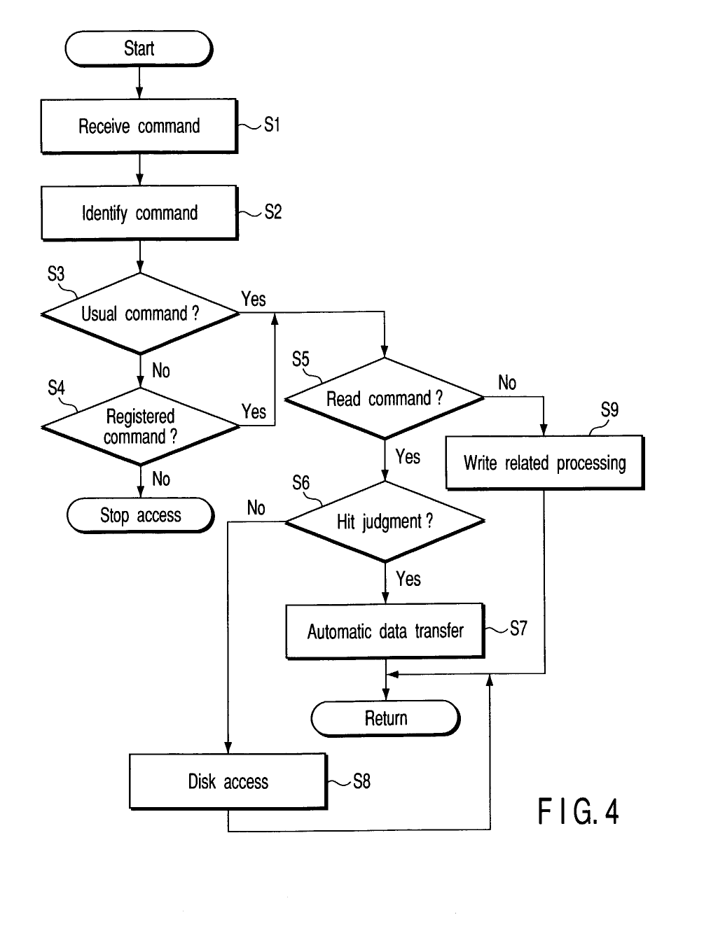

A processing procedure of the read/write command of the present embodiment will be described hereinafter mainly with reference to a flowchart of FIG. 4.

On receiving the command issued from the host system 18, the HDC 15 of the disk drive 17 starts a read/write access in response to the command (step S1). The host IF 20 of the HDC 15 holds the command code from the host system 18 in the command register 300, and further sets the code in the copy register 31.

Here, in the present embodiment, it is assumed that the host system 18 issues the extended read command corresponding to the AV command in order to reproduce the AV data recorded on the disk 1.

The command judgment logic 34 executes identification processing of the usual read/write command and extended read/write command (step S2). Here, the extended read command is assumed. Therefore, the command judgment logic 34 compares the code of the extended read command set in the copy register 31 with the command code set in the register 340 for registering the extended read command, and judges whether or not the codes agree with each other (step S4).

The command judgment logic 34 judges that the extended read command issued from the host system 18 is different from the command code set/registered beforehand. In this case, the host IF 20 stops the access operation, and informs the host system 18 of this (NO of step S4).

In short, even if the arbitrary extended command is issued other than the usual read/write command and extended command set/registered beforehand, the HDC 15 does not execute the processing of the extended command.

When the extended read command issued from the host system 18 agrees with the command code set/registered beforehand, the command judgment logic 34 judges the read command to be usual and starts up the control block 35 (YES of step S4, YES of step S5). Here, when the extended command issued from the host system 18 agrees with the code of the extended write command set/registered beforehand, the host IF 20 shifts to the processing of the usual write command (NO of step S5, S9).

In the control block 35, as with the processing of the usual read command, the hit judgment logic 350 judges whether or not the address (LBA address) designated with the extended read command is registered in the table for hit judgment (step S6).

That is, by a pre-read operation by a read cache method, it is judged whether or not the data (AV data) required by the host system 18 is accumulated in the buffer RAM 22. In the case of a hit, the hit judgment logic 350 instructs the buffer IF 21 to perform an automatic data transfer (YES of step S6, S7). That is, the buffer IF 21 reads out the data (AV data) required by the host system 18 from the buffer RAM 22, and transfers the data to the host IF 20. The host IF 20 transfers the data required by the extended read command to the host system 18.

On the other hand, when the hit judgment logic 350 does not hit the data, the logic instructs the disk IF 24 to access the disk (NO of step S6, S8). That is, since the data (AV data) required by the host system 18 does not exist in the buffer RAM 22, the read operation is executed with respect to the disk 1.

Concretely, the CPU 10 is involved, and the required data read out from the disk 1 by the read head 30 is transferred to the disk IF 24 via the R/W channel 13. The disk IF 24 once accumulates the required data in the buffer RAM 22 via the buffer IF 21. Subsequently, the buffer IF 21 reads out the required data from the buffer RAM 22, and transfers the data to the host IF 20.

As described above, according to the present embodiment, when the extended read/write command different from the usual read/write command is issued, and when the extended command is a valid command code set/registered beforehand, the command is processed as the usual read/write command. Therefore, the CPU 10 is not involved, and an automatic and high-speed read/write access system can be applied as with the usual read/write command.

Particularly, for access to the AV data, high-speed processing within a limited time is required. When the extended command such as the AV command for handling the AV data is newly added, automatic and high-speed read/write access processing can be realized by the method of the present embodiment as with the usual read/write command.

(First Modification Example)

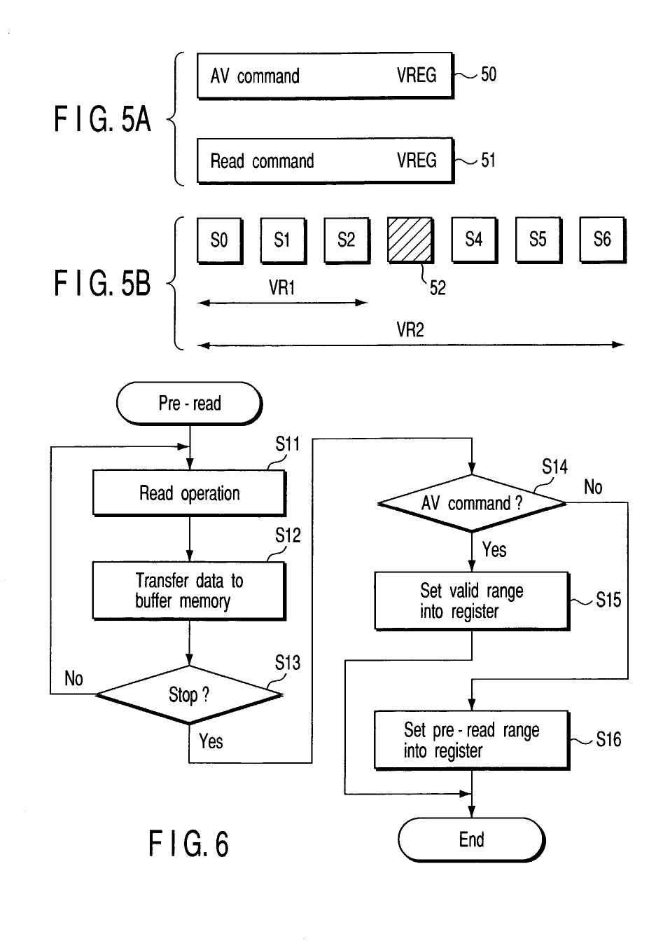

FIGS. 5A, 5B and 6 are diagrams related to a first modification example of the present embodiment.

In the modification example, the HDC 15 includes not only command judgment logic 34 but also registers 50, 51 which indicate a valid range of pre-read data in the read cache method (see FIGS. 5A, 5B).

The HDC 15 usually accesses the required data from a designated range on the disk 1 (designated data sector number) in response to the read command, and subsequently accesses the data for a predetermined number of data sectors continued in the designated range (pre-read operation). The buffer IF 21 accumulates the pre-read data together with the required data in the buffer RAM 22. Thereby, when the next read command is issued, the pre-read data is accumulated, and therefore the hit ratio in the hit judgment logic 350 increases.

The modification example will concretely be described hereinafter.

First, as shown in FIG. 6, it is assumed that the disk access is executed in response to the usual read command issued from the host system 18 or the extended read command (AV command) (step S11). Therefore, the pre-read data is sequentially accessed together with the read data required by the command on the disk 1, and stored in the buffer RAM 22 (step S12).

Here, as shown in FIG. 5B, it is assumed that the data for data sectors S0 to S6 are accessed as the pre-read data, and stored in the buffer RAM 22. On the other hand, for the host IF 20, the command judgment logic 34 identifies the read command from the host system 18 to be either the usual read command or the extended read command (AV command).

In the modification example, for example, the buffer IF 21 sets a valid range as the pre-read data in either the register for the AV command 50 or the register for the usual read command 51 in accordance with the judgment result of the command judgment logic 34 after completion of the pre-read operation (YES of step S13). Here, as shown in FIG. 5B, it is assumed that the read data of the data sector S3 is detected as error data 52 by the ECC block 23 in the range of the pre-read data.

When the host system 18 issues the extended read command (AV command), the buffer IF 21 sets a valid range VR2 as the pre-read data in the register for the AV command 50 (YES of step S14, S15). On the other hand, when the host system 18 issues the normal read command, the buffer IF sets a valid range VR1 as the pre-read data in the register for the read command 51 (NO of step S14, S16).

In short, according to the modification example, the valid range of the pre-read data necessary for the read cache function can be changed in accordance with the usual read command or extended read command such as the AV command from the host system 18. Concretely, the data accessed in accordance with the usual read command is computer data, and the like, and it is necessary to exclude the error data 52 from the pre-read data. On the other hand, even when the stream data such as the AV data includes the error data 52, preference is given to continuity of the data because of little influence or reproduction quality. Therefore, for the pre-read data used as the read cache function, the valid range is preferably changed in accordance with the type of the command from the host system. In the method of the modification example, the valid range of the pre-read data can be changed in accordance with the type of the read command.

### SECOND MODIFICATION EXAMPLE

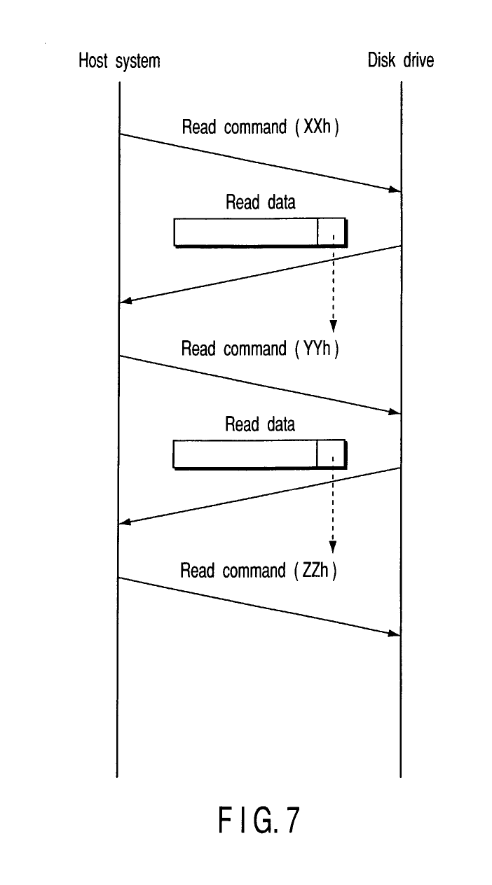

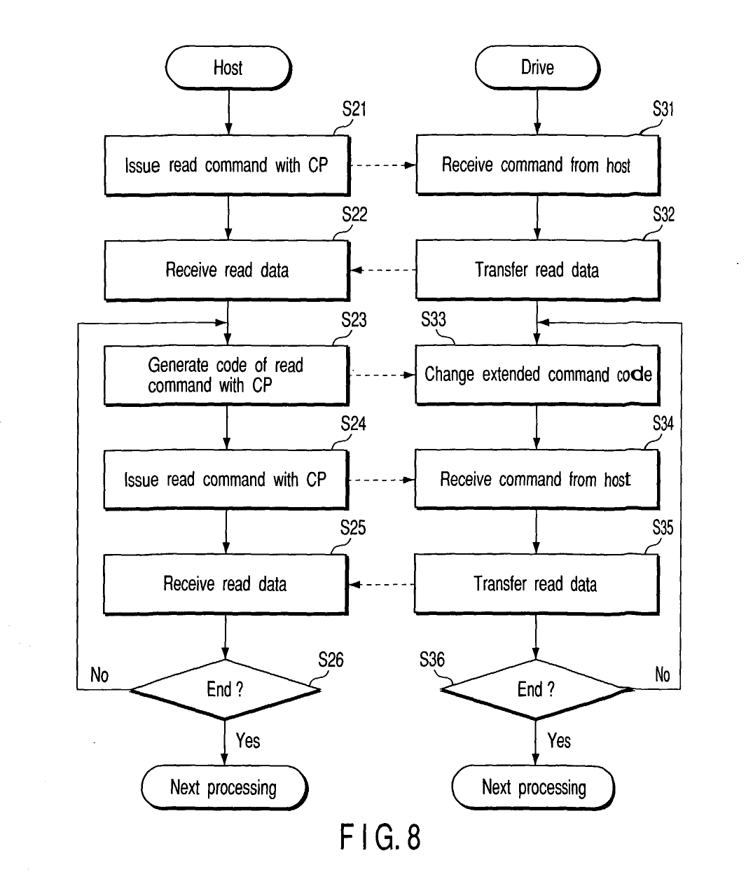

FIGS. 7, 8 are diagrams relating to a second modification example of the present embodiment.

The modification example relates to a command processing method for realizing a content protection (CP) function which dynamically changes the above-described extended read/write command in response to a request from the host system 18 and which can particularly prohibit access to the data recorded on the disk (e.g., AV contents).

The command processing method of the modification example will concretely be described hereinafter.

First, it is assumed that the extended read command with a CP function (code XXh) is set/registered beforehand as an extended read command code in the register 340 included in the command judgment logic 34 in the HDC 15.

As shown in FIGS. 7, 8, the host system 18 issues the extended read command with the CP function (code XXh) (step S21). On receiving the command from the host system 18, the HDC 15 of the disk drive 17 judges validity of the extended read command with the CP function and reads/accesses the command as the usual read command as described above (steps S31, S32).

On receiving the data (AV data) required by the extended read command with the CP function, the host system 18 generates a second extended read command with the CP function (steps S22, S23).

Here, the host system 18 uses the last one byte (YYh) of the read data received by the first access as the command code of a new extended read command with the CP function (see FIG. 7). In response to the request from the host system 18, the HDC 15 changes the extended read command code (XXh) set/registered in the register 340 to the extended read command with the CP function (YYh) (step S33).

As shown in FIG. 7, the host system 18 issues the extended read command with the CP function (code YYh) (step S24). On receiving the command from the host system 18, the HDC 15 of the disk drive 17 judges the validity of the extended read command with the CP function and reads/accesses the command as the usual read command as described above (steps S34, S35).

Thereafter, on receiving the data (AV data) required by the extended read command with the CP function, the host system 18 similarly generates a third extended read command with the CP function (ZZh) (see FIG. 7). In response to the request from the host system 18, the HDC 15 changes the extended read command code (YYh) set/registered in the register 340 to a new extended read command with the CP function (ZZh). This processing is repeated until the host system 18 reads/accesses all the required data (steps S26, S36).

As described above, according to the method of the modification example, for example, the host system 18 dynamically changes the extended read command with the content protection (CP) function and can thereby limit the access to the AV data requiring the CP. In other words, in the disk drive accessible from a plurality of host systems, the read access with the CP function can be realized so that only the specific host system can access the drive.

As described above, there can be provided a disk storage apparatus in which an automatic and high-speed read/write access system can be applied to extended commands such as an AV command other than the usual read/write command. Therefore, for example, when the extended commands such as the AV command for handling the AV data are newly added, automatic and high-speed read/write access can be realized.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A disk drive comprising:
a read/write mechanism which executes a read/write operation of data with respect to a disk medium; and
a controller to execute control related to said read/write operation in accordance with a command issued from a host system, to judge whether or not the command is a registered specific read/write command, and to control said read/write mechanism in a similar way to a usual read/write command, when the judgment result indicates said specific read/write command.

2. A disk drive according to claim 1, wherein said controller includes a command registration unit which registers the specific read/write command different from the usual read/write command.

3. A disk drive according to claim 1, wherein said specific read/write command includes an extended command set separately from the usual read/write command indicating a usual read/write operation, and
said controller executes the control in accordance with said extended command, different from the control by said usual read/write command, when the controller receives the unregistered extended command from said host system.

4. A disk drive according to claim 1, wherein said controller includes:
an access control unit which controls said read/write mechanism in accordance with said usual read/write command;
a command registration unit which registers the specific read/write command; and
a command judgment unit to compare a command received from said host system with the specific read/write command registered by said command registration unit, to judge whether or not the commands agree with each other, and to instruct said access control unit to execute a control similar to that of said usual read/write command, when the judgment result indicates agreement.

5. A disk drive according to claim 1, wherein said controller prohibits the read/write operation by said read/write mechanism, when the command issued from the host system is different from either said usual read/write command or the registered specific read/write command.

6. A disk drive according to claim 1, wherein said controller includes:
a first register in which a command code issued from the host system is set; and
a register for registration in which a command code indicating said specific read/write command is registered.

7. A disk drive according to claim 1, wherein said host system dynamically sets said specific read/write command by a predetermined procedure.

8. A disk drive comprising:
a read/write mechanism which executes a read/write operation of data with respect to a disk medium;
a read cache mechanism which executes a pre-read operation of pre-reading the data from the disk medium by said read/write mechanism and accumulating the data in a buffer memory; and
a controller which controls the read operation by the read/write mechanism in accordance with a read command issued from a host system,
wherein said controller judges whether the command is either a registered specific read command or a usual read command, and indicates a valid range of the pre-read data accumulated in said buffer memory by said pre-read operation in accordance with the judgment result.

9. A method of access control for a disk drive which comprises a read/write mechanism to execute a read/write operation of data with respect to a disk medium, and a controller to control said read/write mechanism in accordance with a command issued from a host system, the method comprising:
receiving the command issued from said host system;
judging whether or not said received command is a usual read/write command or a specific read/write command registered beforehand; and
controlling said read/write mechanism in a similar way to said usual read/write command, when the command is judged to be said specific read/write command registered beforehand as said judgment result.

10. A method according to claim 9, further comprising:
controlling said read/write mechanism so as to prohibit the read/write operation, when said command is different from said usual read/write command and is not included in said specific read/write command registered beforehand as said judgment result.

11. A method according to claim 9, further comprising:
executing control in accordance with an extended command, when said command is the extended command different from said usual read/write command and not included in said specific read/write command registered beforehand as said judgment result.

12. A method according to claim 9, further comprising:
executing a pre-read operation to pre-read the data from the disk medium by said read/write mechanism and to accumulate the data in a buffer memory; and
judging whether the read command received from the host system is either the usual read command or the specific read command registered beforehand, and indicating a valid range of the pre-read data accumulated in said buffer memory by said pre-read operation in accordance with the judgment result.
